(19) United States
(12) Patent Application Publication
(10) Pub. No.: US 2024/0387805 A1
(43) Pub. Date: Nov. 21, 2024

(54) INTERHALOGEN CATHODE BATTERIES AND ELECTROLYTE FORMULATIONS FOR SAME

(71) Applicants: International Business Machines Corporation, Armonk, NY (US); Sidus Energy, Inc., Milpitas, CA (US)

(72) Inventors: Phillip Medina, San Jose, CA (US); Maxwell Giammona, Fremont, CA (US); Hang Zhou, Changzhou City (CN)

(21) Appl. No.: 18/199,299

(22) Filed: May 18, 2023

(51) Int. Cl. H01M 4/38; H01M 4/583; H01M 10/0567; H01M 10/0568; H01M 10/0569

(52) U.S. Cl. CPC H01M 4/382; H01M 4/583; H01M 10/0567; H01M 10/0568; H01M 10/0569; H01M 2004/027; H01M 2004/028; H01M 2300/0028

(57) ABSTRACT

Three configurations for an interhalogen cathode battery include a lithium-containing anode, a carbon cathode, two chemically distinct halogen-containing compounds (HCC-1 and HCC-2), and an electrolyte formulation with (i) an ionic salt, (ii) >1% by weight of a compound selected from imidazolidinones, N-alkylated ureas, aprotic carbonates, and/or nitriles, and (iii) one or two chemically distinct halogen-containing compounds. In a first configuration, both the carbon cathode and the electrolyte formulation include HCC-1 and HCC-2. In a second configuration, the carbon cathode includes HCC-1 and the electrolyte solution includes HCC-2. In a third configuration, HCC-1 and HCC-2 are present in the electrolyte, but not the cathode. During battery charge, HCC-1 and HCC-2 reversibly form an interhalogen compound within the cathode and during battery discharge, the interhalogen compound dissociates for continued cycling and energy storage.

The subject matter of this disclosure describes activities undertaken within the scope of a joint research agreement that was in place before the effective date of the instant application. The parties to the joint research agreement are International Business Machines Corporation (Armonk, New York, USA) and Sidus Optoelectronics Inc. (Fremont, California, USA).

### TECHNICAL FIELD

The present invention relates generally to rechargeable batteries and more specifically to rechargeable batteries with interhalogen cathodes and electrolyte formulations for same.

### BACKGROUND OF THE INVENTION

Rechargeable batteries are high in demand for a wide range of applications, from small batteries for industrial and medical devices, to larger batteries for electric vehicles and grid energy storage systems. Each application requires a specific set of electrochemical performance characteristics and in many critical and growing application species today, such as EVs, the battery performance remains a major limiting factor for satisfying the high standard of performance required to meet customers' needs.

The most widely used rechargeable batteries are lithium-ion batteries (LIBs). Currently used commercial LIBs have a metal oxide or metal phosphate-based lithium intercalation material as the positive electrode and a carbon-graphite-based intercalation material as the negative electrode. As the LIB is charged and discharged, lithium ions move back and forth between the positive and negative electrodes through a liquid electrolyte. Despite the rapid growth and success of LIBs, these batteries have shortcomings that have prevented LIBs from moving forward into a wider range of applications; these shortcomings include the low energy density of the batteries and the high cost of cathode materials, such as cobalt and nickel. There remains a need in the art for a low cost and high energy battery than can replace LIBs in a wide range of applications.

One alternative to conventional LIBs are lithium metal batteries with halogen cathodes; these batteries have fast peak charge, fast discharge rates, high theoretical energy densities, and specific energies comparable to convention LIB cathodes. There are two types of chemistries that may be used to fabricate halogen and/or metal halide cathodes for lithium metal batteries. One cathode chemistry relies on the electrochemical conversion of halide ions, for example iodide ions, (I, iodine oxidation state=−1) to iodine (I₂, iodine oxidation state=0); this cathode chemistry extracts one electron per iodide ion and has a specific capacity of 211 mAh/g I, but requires 40% or more by weight conductive additive in the cathode to facilitate efficient active material utilization. The other cathode chemistry relies upon the electrochemical conversion of iodine (I, iodine oxidation state=−1) to a mixed or interhalogen species such as iodine monochloride (I—Cl, iodine oxidation state=+1); this cathode chemistry extracts two electrons per iodide ion and increases the specific capacity to ˜422 mAh/g I or ˜360 mAh/g I—Cl, but also requires solubility of chloride as a starting material in the electrolyte. Thus, there remains a need in the art for iodine cathode batteries that do not have the shortcomings of the currently known cathode chemistries for such batteries.

### SUMMARY OF THE INVENTION

The present invention overcomes the need in the art by providing an interhalogen cathode battery comprising an electrolyte formulation comprising two halogen containing compounds (HCC-1 and HCC-2), where the electrolyte formulation facilitates the reversible conversion of the halogen containing compounds into an interhalogen compound in the cathode and the subsequent release of halide ions from the cathode for energy storage and continued cycling.

In one embodiment, the present invention relates to a battery comprising: a lithium-containing anode; a cathode comprising a carbon material; and an electrolyte formulation comprising (i) >1% by weight of a compound selected from the group consisting of imidazolidinones, N-alkylated ureas, aprotic carbonates, nitriles, and combinations thereof, (ii) an ionic salt, and (iii) two chemically distinct halogen-containing compounds, HCC-1 and HCC-2 each have a molar concentration of >0.2 mol/L, wherein HCC-1 contains a different halogen atom from HCC-2 and upon battery charge, HCC-1 and HCC-2 reversibly form an interhalogen compound within the cathode and upon battery discharge, the interhalogen compound dissociates for continued cycling and energy storage.

In another embodiment, the present invention relates to a battery comprising: a lithium-containing anode; a cathode comprising a carbon material and a first halogen-containing compound (HCC-1); and an electrolyte formulation comprising (i) an ionic salt, (ii) >1% by weight of a compound selected from the group consisting of imidazolidinones, N-alkylated ureas, aprotic carbonates, nitriles, and combinations thereof, and (iii) a second halogen-containing compound (HCC-2) with a molar concentration of >0.2 mol/L, wherein HCC-1 and HCC-2 are chemically distinct and contain different halogen atoms and upon battery charge, HCC-1 and HCC-2 reversibly form an interhalogen compound within the cathode and upon battery discharge, the interhalogen compound dissociates for continued cycling and energy storage.

In a further embodiment, the present invention relates to a battery comprising: a lithium-containing anode; a cathode comprising a carbon material and two chemically distinct halogen-containing compounds, HCC-1 and HCC-2, wherein HCC-1 contains a different halogen atom from HCC-2; and an electrolyte formulation comprising (i) an ionic salt, (ii) >1% by weight of a compound selected from the group consisting of imidazolidinones, N-alkylated ureas, aprotic carbonates, nitriles, and combinations thereof, and (iii) HCC-1 and HCC-2 each have a molar concentration >0.2 mol/L, wherein upon battery charge, HCC-1 and HCC-2 reversibly form an interhalogen compound within the cathode and upon battery discharge, the interhalogen compound dissociates for continued cycling and energy storage.

In another embodiment, where HCC-1 and HCC-2 are both within the electrolyte, the molar concentration of HCC-1/HCC-2 is >1 when HCC-1 contains a halogen atom that is lighter than the halogen atom of HCC-2.

In a further embodiment, the imidazolidinones are selected from the group consisting of 1,3-dimethyl-2-imidazolidinone (DMI), N,N′-dimethyl propylene urea (DMPU), 2-imidazolidinone, 4-imidazolidinone, and combinations thereof.

In another embodiment, the N-alkylated ureas are 1,1,3,3-tetramethylurea (TMU) and/or 1,1,3,3-tetraethylurea (TEU).

In a further embodiment, the aprotic carbonates are selected from the group consisting of ethylene carbonate (EC), propylene carbonate (PC), fluoroethylene carbonate (FEC), and combinations thereof.

In another embodiment, the nitriles are selected from the group consisting of acetonitrile, propionitrile, isovaleronitrile, and pivalonitrile.

In a further embodiment, the ionic salt is selected from the group consisting of lithium nitrate (LiNO₃), lithium bix(oxalate)-borate (LiBOB), lithium bis(trifluoromethanesulfonyl)imide (LiTFSI), lithium bis(fluorosulfonyl)imide (LiFSI), lithium hexafluorophosphate (LiPF₆), and combinations thereof.

In another embodiment, the electrolyte formulation further comprises an ether selected from the group consisting of dimethoxyethane (DME), tetraglyme (G4), dioxolane (DOL), tetrahydrofuran (THF), and combinations thereof.

In a further embodiment, the battery further comprises an oxidizing gas that reacts with the electrolyte to form an SEI layer on a surface of the lithium-containing anode.

Additional aspects and/or embodiments of the invention will be provided, without limitation, in the detailed description of the invention that is set forth below.

### BRIEF DESCRIPTION OF THE DRAWINGS

FIGS. 1A-1C are schematic illustrations of three configurations of the interhalogen cathode battery described herein.

FIG. 2 is a diagram of a representative battery stack for the interhalogen cathode battery described herein.

FIG. 3 is a cycle graph of an interhalogen cathode battery operated with an electrolyte formulation containing the electrolyte solvent 1,3-dimethyl-2-imidazolidinone (DMI) (Example 1).

FIG. 4 is a specific capacity bar graph of an interhalogen cathode battery operated with an electrolyte formulation containing the electrolyte solvent ethylene carbonate (EC) (Example 2).

FIG. 5 is a specific capacity bar graph of an interhalogen cathode battery operated with an electrolyte formulation containing the electrolyte solvent DMI (Example 3).

FIG. 6 is a cycle graph of the interhalogen cathode battery operated with an electrolyte formulation that does not include an electrolyte solvent as described herein (Comparative Example°1).

FIG. 7 is a specific capacity bar graph of an interhalogen cathode battery operated with an electrolyte formulation containing the electrolyte solvent N-methyl-2-pyrrolidone (NMP) (Comparative Example 2).

FIG. 8 is a specific capacity bar graph of an interhalogen cathode battery operated with an electrolyte formulation containing the electrolyte solvent dimethylformamide (DMF) (Comparative Example 3).

### DETAILED DESCRIPTION OF THE INVENTION

Set forth below is a description of what are currently believed to be preferred aspects and/or embodiments of the claimed invention. Any alternates or modifications in function, purpose, or structure are intended to be covered by the appended claims. As used in this specification and the appended claims, the singular forms “a,” “an,” and “the” include plural referents unless the context clearly dictates otherwise. The terms “comprise,” “comprised,” “comprises,” and/or “comprising,” as used in the specification and appended claims, specify the presence of the expressly recited components, elements, features, and/or steps, but do not preclude the presence or addition of one or more other components, elements, features, and/or steps.

As used herein, the terms “metal halide” and “metal halide salt” refer to compounds having a metal and a halogen. The metals of metal halides may be any metal in Groups 1 to 16 of the periodic chart but will typically be Group 1 alkali metals or Group 2 alkali earth metals. Examples of Group 1 alkali metals include, without limitation, lithium (Li), sodium (S), potassium (K), rubidium (Rb), cesium (Cs), and francium (Ft, Examples of Group 2 alkali earth metals include, without limitation, beryllium (Be), magnesium (Mg), calcium (Ca), strontium (Sr), barium (Ba), and radium (Ra). The halides of the metal halides will be any halogen in Group 17 of the periodic chart, which include, without limitation, fluorine (F; Mw 18.998 g/mol) chlorine (Cl Mw 35.453 g/mol), bromine (Br; Mw 79.904 g/mol), and iodine (I; 253.8089 g/mol).

As used herein, the term “halide ion” refers to a halogen atom with a negative charge.

As used herein, the term “interhalogen compound” refers to a compound formed from the union of two different halogen atoms.

As used herein, the term “cathode” refers to the positive oxidizing electrode of a battery cell that receives electrons from an external circuit, is reduced during discharging, and transfers the electrons to an external circuit through oxidation luring charging.

As used herein, the term “interhalogen cathode” refers to a cathode that includes an interhalogen compound as defined herein.

As used herein, the term “anode” refers to the negative electrode of a battery cell that transfers electrons to an external circuit through oxidation during discharging, and receives them from an external circuit and is reduced during charging.

As used herein, the term “electrolyte” refers to a material that provides for ion transport between the anode and cathode of a battery cell. An electrolyte acts as a medium for ionic conductivity and transport through its interaction with the anode and the cathode. Upon battery charging, an electrolyte facilitates the movement of ions from the cathode to the anode and on discharge, the electrolyte facilitates the movement of ions from the anode to the cathode. In rechargeable batteries, the electrolyte facilitates ion cycling between the anode and the cathode. Liquid electrolytes generally have three components: a solvent, an ionic salt that facilitates electric conductivity, and additives.

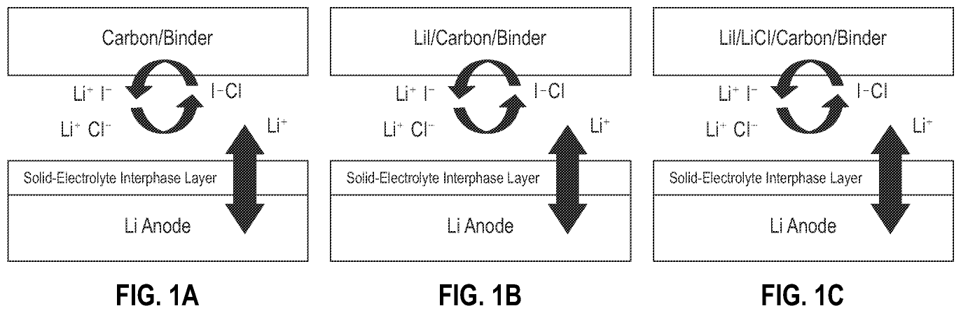

As used herein, the term “oxidizing gas” refers to a gas that induces the reduction-oxidation (redox) reaction in a battery cell. An oxidizing gas may be any gas with >1% O₂; examples including, without limitation, oxygen, air, nitric oxide, nitrogen dioxide, and combinations thereof. As is known to those of skill in the art, a redox reaction is a reaction that transfers electrons between (i) a reducing agent that undergoes oxidation through the loss of electrons and (ii) an oxidizing agent that undergoes reduction through the gain of electrons. It is to be understood that the oxidizing gas is introduced to the battery within the confines of the sealed battery cell where the battery uses the oxidizing gas to induce the redox reaction that runs the battery. Where the oxidizing gas is air, the battery consumes oxygen from the air to run the redox reaction. In addition to promoting the redox reaction, the oxidizing gas works in concert with the electrolyte described herein to form a stable SEI (solid-electrolyte interphase) layer on the surface of the battery anode as shown in FIGS. 1A-1C.

Described herein is a battery comprising an anode, an interhalogen cathode, and an electrolyte formulation required for running the battery. In one embodiment, the anode comprises an alkali metal or an alkali earth metal as described herein and the interhalogen cathode comprises a carbon material and two halogen-containing compounds, HCC-1 and HCC-2, which are chemically distinct metal halide salts that dissociate and associate during battery operation. In the charged state, HCC-1 and HCC-2 react to form an interhalogen compound within the cathode that stores energy and in the discharged state, the interhalogen compound dissociates for continued cycling and energy storage. In one embodiment, upon dissociation, the interhalogen compound releases halide ions from the cathode for the continued cycling and energy storage. Examples of metal halide salts that may be used as HCC-1 and HCC-2 for the interhalogen cathode battery include, without limitation, the lithium halide salts, lithium fluoride (LiF), lithium chloride (LiCl), lithium bromide (LiBr), lithium iodide (LiI), and combinations thereof.

In conventional lithium halide batteries, halogen compounds are introduced into a battery in order to release halogen ions that irreversibly react with lithium in order to stabilize the lithium anode; thus, the halogen compounds act as sacrificial additives that are consumed through reaction with the anode and do not contribute to the usable capacity of the battery. By contrast, the halide ions released from the interhalogen compound in the cathode of the battery described herein do not interact with the anode; rather, the interhalogen compound is a charge product that stores energy.

FIGS. 1A-1C show three possible non-limiting configurations of the interhalogen cathode battery described herein. As shown in each of the three configurations, the formation of the interhalogen compound is a reversable reaction that occurs within the cathode. Illustrating with the exemplary lithium halide salts, LiI and LiCl as HCC-1 and HCC-2, respectively, these two compounds react in a carbon-containing cathode in the presence of an electrolyte formulation to reversibly form I—Cl. In FIG. 1A, HCC-1 and HCC-2 are not fabricated into the carbon cathode, but instead are simultaneously dissolved in the electrolyte formulation and cycled through the cathode where the interhalogen compounds reversibly form and disassociate during operation. In FIG. 1B, one of HCC-1 or HCC-2 is fabricated within the cathode and the other of HCC-1 or HCC-2 is dissolved in the electrolyte formulation (Examples 2 and 3 apply this configuration). In FIG. 1C, HCC-1 and HCC-2 are fabricated into the carbon cathode, either as solids or as one or two solutions. To form the solutions, HCC-1 and HCC-2 may be dissolved together in a solvent (e.g., methanol) and simultaneously introduced into the cathode or applied to the cathode surface (Example 1 applies this configuration), or alternatively, HCC-1 and HCC-2 may be dissolved individually and separately introduced into the cathode or applied to the cathode surface.

Examples of carbon materials that may be used for the cathode include, without limitation, carbon cloth, carbon paper, carbon felt, carbon nanotubes, carbon nanotube arrays, carbon fibers, activated carbon, carbon black, graphene, graphene oxide, reduced graphene oxide, 3D graphene skeleton, pyrolytic graphite, and combinations thereof.

The carbon material of the cathode may include an inorganic additive (i.e., the carbon cathode is a carbon-composite cathode). Examples of inorganic additives that may be added to the carbon cathode to transform it into a carbon-composite cathode include, without limitation, non-electroactive metal halides, such as such for example, iron(III) iodide (FeI₃), manganese(III) iodide (MnI₃), molybdenum(III) iodide (MoI₃), and tungsten(III) iodide (WI₃), and combinations thereof. Unless expressly specified, references to a carbon cathode or a carbon material is meant to include a carbon-composite cathode or a carbon-composite material within the scope of the carbon cathode or carbon material.

The binder may be included in the cathode in order to hold the active material particles together and in contact with the current collector. Examples of binders that may be used in the interhalogen cathode include, without limitation, carboxymethyl cellulose (CMC), polyvinylidene fluoride (PVDF), styrene-butadiene rubber (SBR), and combinations thereof.

Electrolyte solvents that may be used in the electrolyte formulation are selected from the group consisting of ureas, aprotic carbonates, nitriles, and combinations thereof.

Examples of ureas that may be used for the electrolyte solvent include, without limitation, imidazolidinones (5-membered cyclic urea) and N-alkylated ureas. Examples of imidazolidinones include, without limitation, 1,3-dimethyl-2-imidazolidinone (DMI); 1,3-dimethyl-3,4,5,6-tetrahydro-2(1H)-pyrimidinone (also known as N,N′-dimethyl propylene urea, DMPU); 2-imidazolidinone; and 4-imidazolidinone. Examples of N-alkylated ureas include, without limitation, 1,1,3,3-tetramethylurea (TMU) and 1,1,3,3-tetraethylurea (TEU).

Examples of aprotic carbonates that may be used for the electrolyte solvent include, without limitation, ethylene carbonate (EC), propylene carbonate (PC), fluoroethylene carbonate (FEC), and combinations thereof.

Examples of nitriles that may be used for the electrolyte solvent include, without limitation, acetonitrile, propionitrile, isovaleronitrile, and pivalonitrile.

In one embodiment, the electrolyte solvent includes additional solvents, such as for example, an ether. Examples of ethers that may be incorporated into the electrolyte solvent include, without limitation, dimethoxyethane (DME), tetraglyme (G4), dioxolane (DOL), tetrahydrofuran (THF), and combinations thereof.

Examples of ionic salts that may be used in the electrolyte formulation include, without limitation, lithium nitrate (LiNO₃), lithium bix(oxalate)-borate (LiBOB), lithium bis(trifluoromethanesulfonyl)imide (LiTFSI), lithium bis(fluorosulfonyl)imide (LiFSI), lithium hexafluorophosphate (LiPF₆), and combinations thereof.

In one embodiment, the electrolyte solvent comprises a urea and a nitrile. In another embodiment, the electrolyte solvent comprises an imidazolidinone and an aprotic carbonate. In a further embodiment, the electrolyte solvent comprises DMI and/or EC.

The electrolyte formulation that facilitates the conversion chemistry of the interhalogen compound will vary depending on whether the interhalogen cathode battery has the configuration of FIG. 1A, 1B, or 1C.

Where the battery has the configuration of FIG. 1A where HCC-1 and HCC-2 are present in the electrolyte, but not in the cathode or FIG. 1C where HCC-1 and HCC-2 are present in the electrolyte and the cathode, the electrolyte formulation comprises (i) >1% by weight of a compound selected from the group consisting of imidazolidinones, N-alkylated ureas, aprotic carbonates, nitriles, and combinations thereof; (ii) an ionic salt; and (iii) the two chemically distinct halogen-containing compounds, HCC-1 and HCC-2, each with a molar concentration of >0.2 mol/L, wherein HCC-1 contains a different halogen atom from HCC-2.

Where the battery has the configuration of FIG. 1B where HCC-1 is in the cathode and HCC-2 is in the electrolyte, the electrolyte formulation comprises (i) an ionic salt; (ii) >1% by weight of a compound selected from the group consisting of imidazolidinones, N-alkylated ureas, aprotic carbonates, nitriles, and combinations thereof; and (iii) HCC-2 in a molar concentration of >0.2 mol/L, wherein HCC-2 is chemically distinct from HCC-1 and HCC-1 and HCC-2 contain different halogen atoms.

With reference to the % weight of the electrolyte compound, in Example 2, the combined weight of all of the electrolyte compounds is 1322 g with the EC making up 264 g of the formulation, which represents 20% by weight of the electrolyte formulation. In Example 3, the 212 g of DMI represents 16% by weight of the electrolyte formulation.

It is to be understood that the >0.2 mol/L molar concentration for each of HCC-1 and HCC-2 applies to the molar concentration of the compounds and is independent of the solubility of the compounds in the electrolyte solution. By way of example, with reference to Example 1, the molar concentrations of the 14 mg LiI (mol. wt. 133.85 g/mol; specific gravity 1.65 g/mL) in the 60 μL of electrolyte is 1.74 mol/L and the 4 mg LiCl (mol. wt. 42.394 g/mol; specific gravity 2.07 g/mL) in the 60 μL electrolyte is 1.57 mol/L. In Examples 2 and 3, the 32 mg of LiI in the 60 μL electrolyte formulation results in a molar concentration of 3.98 mol/L for the LiI.

In a further embodiment, the ratio (in terms of molar concentration) of HCC-1/HCC-2 is ≥1 when HCC-1 contains a halogen atom that is lighter than the halogen atom of HCC-2. By way of example, with reference to Example 1, the iodine atom in LiI has a mol. wt. of 253.81 g/mol and the chlorine atom in LiCl has a mol. wt. of 35.453 g/mol; thus HCC-1 is LiCl and HCC-2 is LiI. Because both LiCl and LiI both have a molar concentration of 0.105 mol/L, the ratio of LiCl/LiI=1.

In another embodiment, HCC-1 and/or HCC-2 comprise approximately 50% by weight of the cathode as prepared. Byway of illustration, in Example 1, the carbon cathode prepared therein is 6 mg and the amount of HCC-1 (LiCl) and HCC-2 (LiI) applied to the cathode is also 6 mg; thus, HCC-1 and HCC-2 represent 50% by weight of the cathode. In Examples 2 and 3, the carbon cathode is also 6 mg and the amount of HCC-2 (LiI) applied to the cathode is also 6 mg. In Example 2, the HCC-1 (LiCl) is introduced into the cathode by way of the electrolyte formulation. In order for the interhalogen cathode battery to run most efficiently, the amount of HCC-1 and/or HCC-2 applied to the cathode may be more than, but should not be less than 50% of the weight of the cathode as prepared. Thus, in a further embodiment, the amount of HCC-1 and/or HCC-2 may comprise >50% by weight of the cathode as prepared. It is to be understood that the cathode as prepared may include binders and/or inorganic additives as described herein.

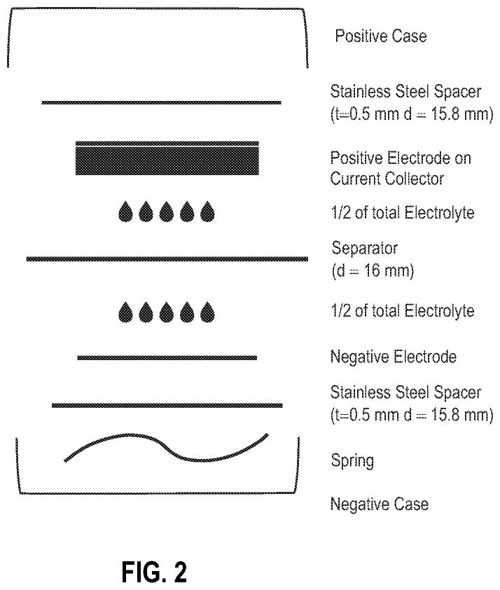

Once the interhalogen cathode, the anode, and the electrolyte formulation are prepared, the battery components may be assembled in a battery container, such as for example, a 2032 type coin cell, a 2032 type button cell, a cylindrical cell, a prismatic cell, or a pouch cell. Example 1 describes the fabrication of an interhalogen battery as described herein in a 2032 type coin cell and FIG. 2 shows a non-limiting example of a coin, button, or cylindrical cell battery stack configuration. As shown therein, the battery includes a positive case and a negative case at each end of the battery, which houses two stainless steel spacers within each end of the battery case.

In one embodiment, the internal infrastructure of the battery cell allows for the containment of an oxidizing gas within the battery cell thus eliminating the need for external infrastructure to manage gas generation and materials flow. With reference to FIG. 2, upon the sealing of the battery container, any oxidizing gas introduced into the battery stack becomes trapped in the container headspace within the sealing atmosphere of the battery cell, thus becoming available for reacting with the electrolyte to induce the redox reaction that runs the battery. The oxidizing gas may also enhance the performance of the interhalogen cathode battery by reacting with the electrolyte to facilitate the early formation of a protective solid-electrolyte interphase (SEI) layer on the surface of the anode as shown in FIGS. 1A-1C, thus inhibiting electrolyte decomposition and extending the life of the battery. The lack of external infrastructure for introduction of an oxidizing gas makes the interhalogen cathode battery described herein suitable for mobility applications, such as electric vehicles.

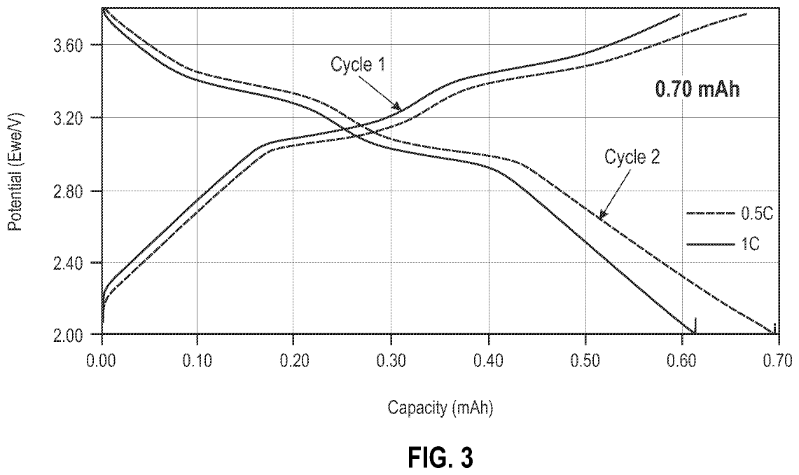

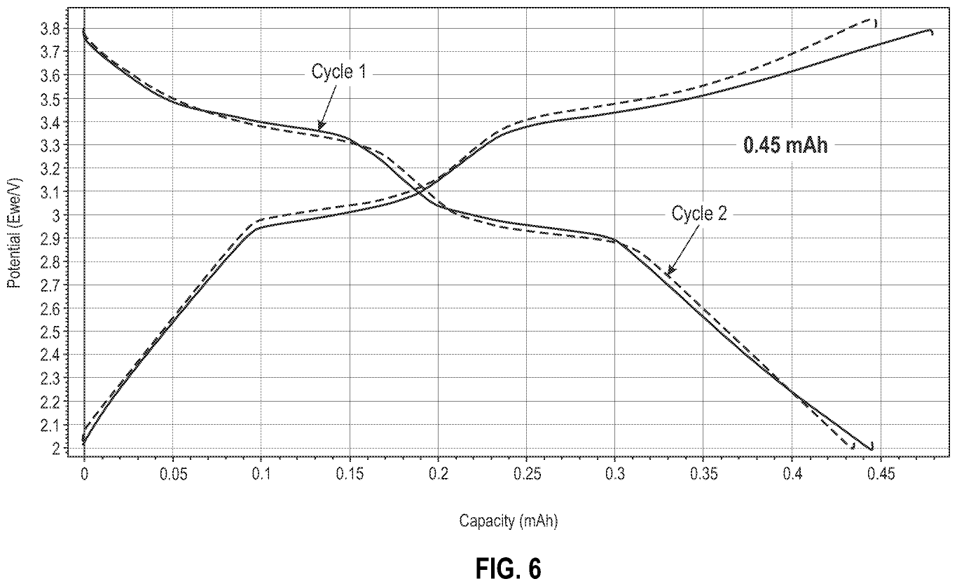

Examples 1-3 describe the fabrication and operation of three interhalogen cathode batteries with the electrolyte formulations as described herein and Comparative Examples 1-3 describe the fabrication and operation of three interhalogen cathode batteries with electrolyte formulations that do not include an electrolyte solvent selected from an imidazolidinone, N-alkylated ureas, aprotic carbonates, and nitriles. In Example 1, the electrolyte formulation includes the imidazolidinone DMI. In Comparative Example 1, the battery is the same as the battery of Example 1 with the exception of the DMI, which is missing from the electrolyte formulation. As shown in FIG. 3 (for Example 1) the battery with the DMI-containing electrolyte formulation has a specific capacity of 0.7 mAh. By comparison in FIG. 6 (for Comparative Example 1), the omission of the DMI from the electrolyte formulation results in a battery with a reduced specific capacity of 0.45 mAh.

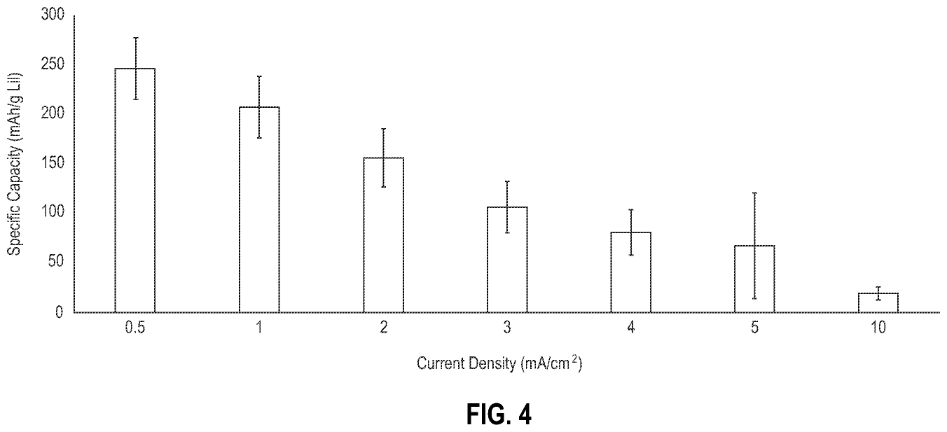

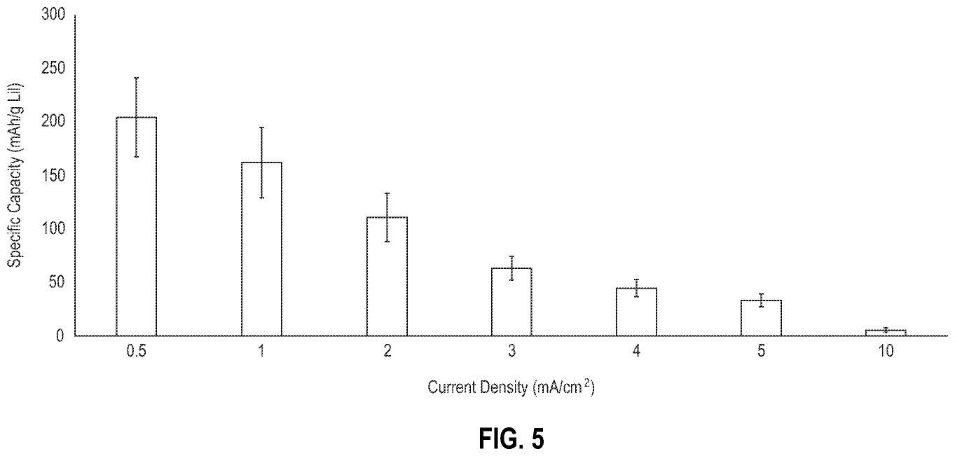

The batteries in Example 1 and Comparative Example 1 were prepared according to the configuration shown in FIG. 1C where the LiI and LiCl are both applied to a carbon film. In Examples 2 and 3 and Comparative Examples 2 and 3, the batteries were prepared according to the configuration shown in FIG. 1B where only LiI is applied to a carbon film and the I—Cl interhalogen compound is formed when the LiCl from the electrolyte formulation is introduced into the cathode during operation. In addition to LiCl, the electrolyte formulation in Example 2 uses the aprotic carbonate EC and the electrolyte formulation in Example 3 uses DMI. FIG. 4 shows that the interhalogen cathode battery operated with the EC-containing electrolyte formulation achieved a specific capacity of ˜250 mAh/g LiI after five cycles (each bar representing five cycles) and that at 30 cycles, the battery was still operating at a specific capacity of ˜50 mAh/g LiI. FIG. 5 shows that the interhalogen cathode battery operated with the DMI-containing electrolyte formulation achieved a specific capacity of ˜200 mAh/g LiI after five cycles and that at 25 cycles, the battery was still operating at a specific capacity of ˜50 mAh/g LiI.

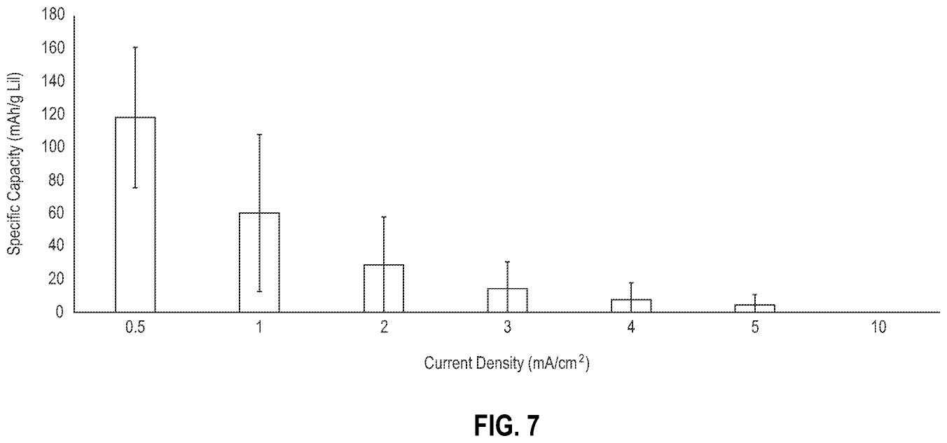

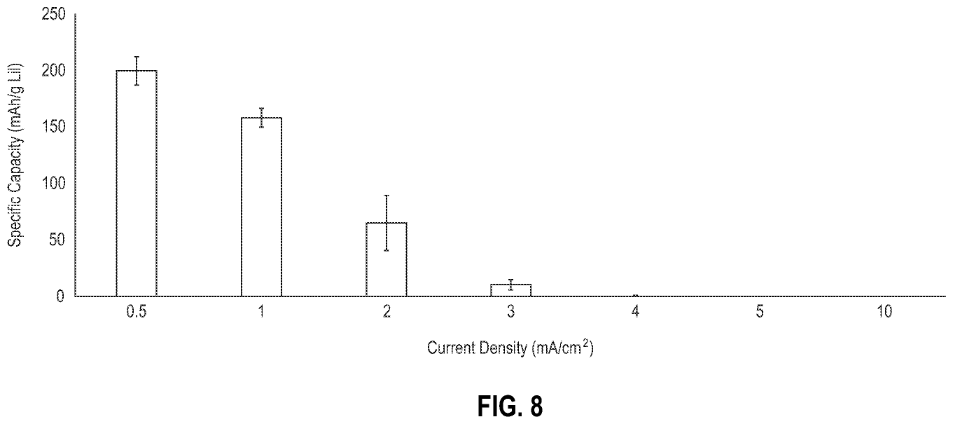

Comparative Examples 2 and 3 replace the EC and DMI of Examples 2 and 3 with N-methyl-2-pyrrolidone (NMP) and dimethylformamide (DMF), respectively. FIG. 7 shows that the battery operated with the NMP-containing electrolyte formulation was only able to achieve a specific capacity of ˜115 mAh/g LiI after five cycles, which dropped to ˜60 mAh/g LiI after ten cycles and ˜25 mAh/g LiI after 15 cycles; by 20 cycles, the battery was essentially no longer operational. FIG. 8 shows that the battery operated with the DMF-containing electrolyte formulation was able to achieve a specific capacity of ˜200 mAh/g LiI after five cycles and ˜150 mAh/g LiI after ten cycles, but that the specific capacity of the battery dropped quickly to ˜50 mAh/g LiI after fifteen cycles; by 20 cycles, the battery was no longer operational.

The descriptions of the various aspects and/or embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the aspects and/or embodiments, the practical application or technical improvement over technologies found in the marketplace, or to enable others of ordinary skill in the art to understand the aspects and/or embodiments disclosed herein.

### EXPERIMENTAL

The following examples are set forth to provide those of ordinary skill in the art with a complete disclosure of how to make and use the aspects and embodiments of the invention as set forth herein. While efforts have been made to ensure accuracy with respect to variables such as amounts, temperature, etc., experimental error and deviations should be considered. Unless indicated otherwise, parts are parts by weight, temperature is degrees centigrade, and pressure is at or near atmospheric. All components were obtained commercially unless otherwise indicated.

### Example 1

A 60 uL electrolyte formulation was prepared with the following materials: a 2:2:1 DOL/DME/DMI solvent mixture with LiTFSI (100 mg), LiBOB (40 mg), LiNO₃ (14 mg), LiCl (4 mg), and LiI (14 mg).

A carbon-containing cathode was prepared by from a slurry containing activated carbon (MSC-30SS, Kansai Coke & Chemicals Co., Ltd, Amagasaki, Japan), high conductivity carbon black (Ketjen Black, Lion Chemical Corp., Manila, Philippines), styrene-butadiene rubber (SBR), carboxy methyl cellulose (CMC), and high purity water. The slurry was mixed using a rotary mixer (a tumble mixer can also be used), coated using the doctor blade technique onto a stainless-steel current collector, and dried to produce a carbon film. To form the interhalogen carbon cathode, LiI and LiCl were dissolved together in methanol and applied to the surface of the prepared carbon film. The weight of the cathode as prepared was approximately 6 mg and approximately 6 mg of the combined LiI and LiCl was applied to the cathode to formulate the interhalogen cathode.

A lithium metal anode (Honjo Metal Co., Ltd., Osaka, Japan) was mounted onto a current collector and placed atop a stainless-steel spacer (t=0.5 mm; d=15.8 mm) situated above a wave spring inside of the negative cap of a 2032 type coin cell. Next, 30 μL of electrolyte was applied to the anode surface followed by a 2325-type CELGARD® (Celgard, LLC, Charlotte, NC, USA) microporous membrane (d=16 mm). The remaining 30 μL portion of the electrolyte was added to the membrane and the interhalogen-coated cathode was mounted on a current collector and placed atop the separator. A stainless-steel spacer (t=0.5 mm; d=15.8 mm) was placed atop the cathode current collector followed by the placing of the positive cap of the 2032 cell atop the stainless-steel spacer. The coin cell was sealed with a coin cell crimper. Air as an oxidizing gas was introduced into the battery stack upon the sealing of the coin cell. The configuration of the coin cell as described herein is shown schematically in FIG. 2.

Cycling curves for the battery cell are shown in FIG. 3 where the solid curves are the charge discharge curves of the battery specific capacity cycle 1 and the dashed curves are the charge discharge curves of the battery specific capacity at cycle 2.

### Example 2

A CR2032 button cell was fabricated with a carbon film cathode and a lithium metal anode as described in Example 1. The cathode differed from Example 1 in that only dissolved LiI was applied to the surface of the prepared carbon film to form the interhalogen carbon cathode. Here, the weight of the cathode was also approximately 6 mg and approximately 6 mg of LiI was applied to the cathode to form the interhalogen cathode. A 60 μL electrolyte formulation was prepared with the following materials: LiCl (32 mg), LiTFSI (144 mg), LiNO₃ (14 mg), LiBOB (40 mg), G4 (404 mg), DOL (424 mg), and EC (264 mg). The average specific capacity for the battery cell was cycled (charged and discharged) at various current densities as shown in FIG. 4 where each bar is an average of five cycles and the error bars show a capacity standard deviation of +/−1.

### Example 3

A CR2032 button cell was fabricated with a carbon film cathode containing LiI and a lithium metal anode as described in Example 2. A 60 μL electrolyte formulation was prepared with the following materials: LiCl (32 mg), LiTFSI (144 mg), LiNO₃ (14 mg), LiBOB (40 mg); G4 (404 mg), DOL (424 mg), and DMI (212 mg). The average specific capacity for the battery cell was cycled (charged and discharged) at various current densities as shown in FIG. 5 where each bar is an average of five cycles and the error bars show a capacity standard deviation of +/−1.

### Comparative Example 1

A conventional lithium battery electrolyte formulation at a volume of 60 uL was prepared with a 1:1 DOL/DME solvent mixture with 100 mg/mL LiTFSI, 40 mg/mL LiBOB, 14 mg/mL LiNO₃, 14 mg/mL LiI, and 4 mg/mL LiCl.

A cathode was prepared by from a slurry containing activated carbon (MSC-30SS, Kansai Coke), high conductivity carbon black (Ketjen Black, Lion Chemical), Styrene-Butadiene Rubber, and Carboxy-Methyl Cellulose and high purity water. The slurry was mixed using a rotary mixer (a tumble mixer can also be used), coated using the doctor blade technique onto a stainless-steel current collector, and dried to produce a carbon film. To form an interhalogen carbon cathode, LiI and LiCl were dissolved together in methanol and applied to the prepared carbon film.

A lithium metal anode (Honjo Metal Co., Ltd., Osaka, Japan) was mounted onto the current collector and placed atop of a wave spring inside of a negative cap of a 2032 type coin cell. Next, a portion of the conventional electrolyte was added onto the anode followed by a piece of microporous membrane 2325 type CELGARD® (Celgard, LLC, Charlotte, NC, USA), another portion of the electrolyte, the cathode, and the positive cap of the 2032 cell. The coin cell was then sealed with a coin cell crimper.

Cycling curves for the battery cell are shown in FIG. 6 where the solid curves are the charge discharge curves of the battery capacity cycle 1 (C1) and the dashed curves are the charge discharge curves of the battery capacity at cycle 3 (C3).

### Comparative Example 2

A CR2032 button cell was fabricated with a carbon film cathode and a lithium metal anode as described in Example 1. The cathode differed from Example 1 in that only dissolved LiI was applied to the prepared carbon film. A 60 μL electrolyte formulation was prepared with the following materials: LiCl (32 mg), LiTFSI (144 mg), LiNO₃ (14 mg), LiBOB (40 mg), G4 (404 mg), DOL (424 mg), and DMF (189 mg). The average specific capacity for the battery cell was cycled (charged and discharged) at various current densities as shown in FIG. 7 where each bar is an average of five cycles and the error bars show a capacity standard deviation of +/−1.

### Comparative Example 3

A CR2032 button cell was fabricated with a carbon film cathode containing LiI and a lithium metal anode as described in Comparative Example 2. A 60 μL electrolyte formulation was prepared with the following materials: LiCl (32 mg), LiTFSI (144 mg), LiNO₃ (14 mg), LiBOB (40 mg), G4 (404 mg), DOL (424 mg), and NMP (206 mg). The average specific capacity for the battery cell was cycled (charged and discharged) at various current densities as shown in FIG. 8 where each bar is an average of five cycles and the error bars show a capacity standard deviation of +/−1.

We claim:

1. A battery comprising:
a lithium-containing anode;
a cathode comprising a carbon material; and
an electrolyte formulation comprising (i) >1% by weight of a compound selected from the group consisting of imidazolidinones, N-alkylated ureas, aprotic carbonates, nitriles, and combinations thereof, (ii) an ionic salt, and (iii) two chemically distinct halogen-containing compounds, HCC-1 and HCC-2 each with a molar concentration of >0.2 mol/L,
wherein HCC-1 contains a different halogen atom from HCC-2 and upon battery charge, HCC-1 and HCC-2 reversibly form an interhalogen compound within the cathode and upon battery discharge, the interhalogen compound dissociates for continued cycling and energy storage.

2. The battery of claim 1, wherein the molar concentration of HCC-1/HCC-2 is >1 when HCC-1 contains a halogen atom that is lighter than the halogen atom of HCC-2.

3. The battery of claim 1, wherein the imidazolidinones are selected from the group consisting of 1,3-dimethyl-2-imidazolidinone (DMI), N,N′-dimethyl propylene urea (DMPU), 2-imidazolidinone, 4-imidazolidinone, and combinations thereof.

4. The battery of claim 1, wherein the N-alkylated ureas are 1,1,3,3-tetramethylurea (TMU) and/or 1,1,3,3-tetraethylurea (TEU).

5. The battery of claim 1, wherein the aprotic carbonates are selected from the group consisting of ethylene carbonate (EC), propylene carbonate (PC), fluoroethylene carbonate (FEC), and combinations thereof.

6. The battery of claim 1, wherein the nitriles are selected from the group consisting of acetonitrile, propionitrile, isovaleronitrile, pivalonitrile, and combinations thereof.

7. The battery of claim 1, wherein the ionic salt is selected from the group consisting of lithium nitrate (LiNO₃), lithium bix(oxalate)-borate (LiBOB), lithium bis(trifluoromethanesulfonyl)imide (LiTFSI), lithium bis(fluorosulfonyl)imide (LiFSI), lithium hexafluorophosphate (LiPF₆), and combinations thereof.

8. The battery of claim 1, wherein the electrolyte formulation further comprises an ether selected from the group consisting of dimethoxyethane (DME), tetraglyme (G4), dioxolane (DOL), tetrahydrofuran (THF), and combinations thereof.

9. The battery of claim 1, further comprising an oxidizing gas that reacts with the electrolyte to form an SEI layer on a surface of the lithium-containing anode.

10. A battery comprising:
a lithium-containing anode;
a cathode comprising a carbon material and a first halogen-containing compound (HCC-1); and
an electrolyte formulation comprising (i) an ionic salt, (ii) >1% by weight of a compound selected from the group consisting of imidazolidinones, N-alkylated ureas, aprotic carbonates, nitriles, and combinations thereof, and (iii) a second halogen-containing compound (HCC-2) with a molar concentration of >0.2 mol/L,
wherein HCC-1 and HCC-2 are chemically distinct and contain different halogen atoms and upon battery charge, HCC-1 and HCC-2 reversibly form an interhalogen compound within the cathode and upon battery discharge, the interhalogen compound dissociates for continued cycling and energy storage.

11. The battery of claim 10, wherein the imidazolidinones are selected from the group consisting of 1,3-dimethyl-2-imidazolidinone (DMI), N,N′-dimethyl propylene urea (DMPU), 2-imidazolidinone, 4-imidazolidinone, and combinations thereof.

12. The battery of claim 10, wherein the N-alkylated ureas are 1,1,3,3-tetramethylurea (TMU) and/or 1,1,3,3-tetraethylurea (TEU).

13. The battery of claim 10, wherein the aprotic carbonates are selected from the group consisting of ethylene carbonate (EC), propylene carbonate (PC), fluoroethylene carbonate (FEC), and combinations thereof.

14. The battery of claim 10, wherein the nitriles are selected from the group consisting of acetonitrile, propionitrile, isovaleronitrile, pivalonitrile, and combinations thereof.

15. The battery of claim 10, wherein the ionic salt is selected from the group consisting of lithium nitrate (LiNO₃), lithium bix(oxalate)-borate (LiBOB), lithium bis(trifluoromethanesulfonyl)imide (LiTFSI), lithium bis(fluorosulfonyl)imide (LiFSI), lithium hexafluorophosphate (LiPF₆), and combinations thereof.

16. The battery of claim 10, wherein the electrolyte formulation further comprises an ether selected from the group consisting of dimethoxyethane (DME), tetraglyme (G4), dioxolane (DOL), tetrahydrofuran (THF), and combinations thereof.

17. The battery of claim 10, further comprising an oxidizing gas that reacts with the electrolyte to form an SEI layer on a surface of the lithium-containing anode.

18. A battery comprising:
a lithium-containing anode;
a cathode comprising a carbon material and two chemically distinct halogen-containing compounds, HCC-1 and HCC-2, wherein HCC-1 contains a different halogen atom from HCC-2; and
an electrolyte formulation comprising (i) an ionic salt, (ii) >1% by weight of a compound selected from the group consisting of imidazolidinones, N-alkylated ureas, aprotic carbonates, nitriles, and combinations thereof, and (iii) HCC-1 and HCC-2 each have a molar concentration >0.2 mol/L,
wherein upon battery charge, HCC-1 and HCC-2 reversibly form an interhalogen compound within the cathode and upon battery discharge, the interhalogen compound dissociates for continued cycling and energy storage.

19. The battery of claim 18, wherein the molar concentration of HCC-1/HCC-2 is >1 when HCC-1 contains a halogen atom that is lighter than the halogen atom of HCC-2.

20. The battery of claim 18, wherein the imidazolidinones are selected from the group consisting of 1,3-dimethyl-2-imidazolidinone (DMI), N,N′-dimethyl propylene urea (DMPU), 2-imidazolidinone, 4-imidazolidinone, and combinations thereof.

21. The battery of claim 18, wherein the N-alkylated ureas are 1,1,3,3-tetramethylurea (TMU) and/or 1,1,3,3-tetraethylurea (TEU).

22. The battery of claim 18, wherein the aprotic carbonates are selected from the group consisting of ethylene carbonate (EC), propylene carbonate (PC), fluoroethylene carbonate (FEC), and combinations thereof.

23. The battery of claim 18, wherein the nitriles are selected from the group consisting of acetonitrile, propionitrile, isovaleronitrile, pivalonitrile, and combinations thereof.

24. The battery of claim 18, wherein the ionic salt is selected from the group consisting of lithium nitrate (LiNO₃), lithium bix(oxalate)-borate (LiBOB), lithium bis(trifluoromethanesulfonyl)imide (LiTFSI), lithium bis(fluorosulfonyl)imide (LiFSI), lithium hexafluorophosphate (LiPF₆), and combinations thereof.

25. The battery of claim 18, wherein the electrolyte formulation further comprises an ether selected from the group consisting of dimethoxyethane (DME), tetraglyme (G4), dioxolane (DOL), tetrahydrofuran (THF), and combinations thereof.

26. The battery of claim 18, further comprising an oxidizing gas that reacts with the electrolyte to form an SEI layer on a surface of the lithium-containing anode.
